(19) United States
(12) Patent Application Publication
(10) Pub. No.: US 2020/0383312 A1
(43) Pub. Date: Dec. 10, 2020

(54) A METHOD AND APPARATUS FOR CONTROLLING VEGETATION BY MEANS OF A HEATED GAS

(71) Applicant: AGROFROST NV, Brussel (BE)

(72) Inventor: Marc Guy POLLEUNIS, Kortenaken (BE)

(21) Appl. No.: 16/772,539

(22) PCT Filed: Dec. 14, 2018
(86) PCT No.: PCT/EP2018/085091

§ 371 Date: Jun. 12, 2020

(30) Foreign Application Priority Data
Dec. 15, 2017 (BE) BE2017/5944
Oct. 15, 2018 (BE) BE2018/5704

(51) Int. Cl. A01M 21/04; A01G 13/06

(52) U.S. Cl. CPC A01M 21/04; E01H 11/00; A01G 13/06

(57) ABSTRACT

A method and apparatus are described for the control of vegetation by means of a heated gas that is generated in a burner and which via an outflow opening of an outlet channel is passed to the vegetation to be controlled. A fan is arranged between the burner and the outlet channel in order for the fan, while in operation, to suck in the heated gas from the burner and discharge it to the outlet channel and thereby exhibiting a flame-retarding action.

### TECHNICAL DOMAIN

The invention relates to a method and an apparatus for controlling vegetation by means of a heated gas. More specifically controlling for instance weed by means of a heated gas that is generated in a burner.

### STATE OF THE ART

A method and apparatus for controlling weed by means of a heated gas is for instance known from U.S. Pat. No. 3,112,742. The apparatus comprises a burner for generating the heated gas. The burner comprises an outflow opening from which the heated gas is passed to the weed to be controlled. A known drawback of such an apparatus is the risk in terms of fire safety. As can be seen, the burner is situated at the outflow opening, as a consequence of which in addition to the heated gas an open flame also exits the outflow opening in order to control the weed. It goes without saying that such a flame may cause a fire hazard, in particular in an environment where for instance dried plant material is present. As can be seen, in such a burner the air to be heated is supplied to the burner by means of an impeller and a conduit, which burner is positioned near the outflow opening. In addition, the air flow generated by the impeller is hindered by the presence of for instance the components of the burner elements in the flow path from the impeller up to the outflow opening.

An alternative method and apparatus for thermal weed control is also known from US2010/0024291 wherein air is supplied to a burner via a ventilator after which the heated air flows to the weed via a discharge aperture. Again, there is a direct path from the burner to the discharge aperture and therefore a risk that the flame reaches the discharge aperture and constitutes a fire hazard. To reduce the treatment time, preheating is made use of by conducting the air blown out by the ventilator along the burner casing before it enters the burner area. This embodiment discloses an apparatus that can be attached on or to a vehicle, such as for instance a tractor.

Therefore, there is a need for an improved apparatus and method for controlling vegetation wherein the flow rate of the heated gas can be increased in order to let the treatment run more rapidly and efficiently, and wherein the risk of a fire is reduced.

### SUMMARY

To that end, according to a first aspect of the invention a method is provided for controlling vegetation by means of a heated gas that is generated in a burner and which via an outflow opening of an outlet channel is passed to the vegetation to be controlled,

### CHARACTERIZED IN THAT

between the burner and the outlet channel a fan is arranged such that the fan, while in operation, sucks in the heated gas from the burner and discharges it to the outlet channel and thereby exhibits a flame-retarding action.

Because the fan is arranged between the outlet channel and the burner and while in operation has a flame-retarding action, the fire hazard is considerably reduced. This allows for the flow rate of the gas to be increased by means of the fan and the heating to be forced up by means of the burner without this causing an increased risk of flames reaching the outflow opening. As a result, a more efficient treatment of the vegetation can be realized. This for instance means that the period of time that the vegetation must be exposed to the heated gas can be reduced. In case of an apparatus attached to a vehicle, this for instance means the driving speed can be increased and that a larger surface area can be treated in a specific period of time. It is clear that while in operation, the fan constitutes an impediment for the flames of the burner. Furthermore, while in operation, the fan also ensures the realization of a specific pressure increase in the heated gas, as a result of which the fire-retarding action is enhanced. Said pressure increase furthermore ensures that the heated gas is blown onto the plants with an increased pressure and flow rate. This ensures an accelerated action of the heat of the heated gas onto the cells of the vegetation, because of which the cells of the vegetation dry out or their cell walls get damaged. As a result, the treatment time of the vegetation can be reduced without increasing the risk of a fire. It is clear that such a treatment according to the method according to the invention is capable of realizing this increased efficiency without making use of burning the plants by means of an open flame at the outflow opening of the outlet channel. In other words, the vegetation is treated by the heated gas without exposing the vegetation directly to flames and/or radiation heat caused by the combustion process in the burner. The heat generated by the burner is therefore only passed to the vegetation to be treated by flow or convection via the heated gas. Due to the heated gas being blown out under pressure, the efficiency of the treatment of the vegetation can also be enhanced without having to force up the temperature of the heated gas to such a level as to cause an increased fire hazard as well, or that for instance additional safety precautions, such as water jackets or cooling elements, need to be taken to avoid the risk of the user getting burned when using the method. The parts of the apparatus, in particular the outlet channel, but the burner as well for instance, are thus also exposed to more temperate temperatures, which is advantageous as simpler and more inexpensive materials and parts can be utilized.

Furthermore, as the fan is arranged between the burner and the outlet channel, it means that the heated gas blown into the outlet channel by the fan, is no longer impeded by elements of the burner, as a result of which it can flow to the outflow opening more efficiently and at a higher flow rate. It is clear that this also makes a more efficient treatment of the vegetation possible. This more efficient configuration also ensures that the energy consumption required for the fan and the burner can be optimized and that the quantity of fuel per surface area of vegetation to be treated can be reduced.

Furthermore, it is clear that flame-retarding action means that the flames created in the burner due to the combustion process of a suitable fuel such as gas for instance, cannot extend beyond the fan. It is clear that this does not mean that the flames are extinguished in the fan itself. In that sense the flame-retarding action of the fan must be considered an action of the fan wherein the passage of the flames from the burner through the fan is prevented or inhibited, and the fan therefore has a flame-inhibiting or flame-stopping action, as it were. It is clear that in general, this flame-retarding action, thus refers to the fact that the risk is reduced that flames or fire reaches or exits the outflow opening, or preferably reduces the risk that flames protrude into and/or along the outlet channel. Such a flame-retarding action could also be referred to as a flame-blocking, flame-extinguishing, etc. action. It is however also clear that this flame-retarding action still allows for a suitable flame to be available in the burner.

It is further clear that in the context of this application, when referring to an apparatus or method for controlling of vegetation by means of heated gas, this refers to for example to the fighting of certain vegetation, such as for example weeds, typically in an outdoor environment, such as for example fighting and/or destruction of weeds or other undesirable vegetation, plants, etc. in agriculture, forestry, etc., but also along roadsides, railways, etc., in gardens, on pavements, etc. It is thus clear that such apparatus or method are typically concerned with thermal weed control, in which use is made of heat for controlling vegetation by either damaging plant tissue or killing a plant.

According to an embodiment, a method is provided wherein:

an inlet opening of the outlet channel is connected to an outlet opening of the fan and the outlet channel forms a closed circuit for the heated gas from the inlet opening up to the outflow opening where the vegetation to be controlled is exposed to the heated gas; and
an outlet opening of the burner is connected to an inlet opening of the fan for sucking in the gas heated by the burner.

That way the heated gas is sucked in from the burner at the inlet of the fan and subsequently, at the outlet of the fan, is discharged via the outlet channel towards the vegetation to be treated. As the fan has a flame-retarding action, the heated gas can be discharged that way towards the vegetation in a more fire-resistant manner.

According to another embodiment, a method is provided wherein no elements that at least partially disrupt the flow of heated gas are arranged in or after the outlet channel.

That way the heated gas can be generated efficiently wherein the flow rate generated by the fan is preserved optimally. That way the energy consumption and/or fuel consumption per treated surface area of the vegetation can be optimized.

According to another embodiment, a method is provided wherein no burner is arranged in or downstream of the outlet channel; and/or no burner is arranged downstream relative to the fan.

It is clear that this way the fire safety is optimized as the risk of flames from a burner being able to reach the vegetation to be treated, is reduced. The absence of a burner downstream of the fan, further ensures that an optimal flow-through of the heated gas to the vegetation to be treated is achieved, as a result of which the treatment can be performed with a more efficient use of energy and/or fuel.

According to another embodiment, a method is provided wherein a pressure-increasing element is arranged near the outlet opening of the fan.

That way the flame-retarding action of the fan can be increased in a simple manner. That way the fan does not only form a mechanical impediment for the flames, but the pressure increase also makes sure there is an extra barrier for the flames from the burner.

According to another embodiment, a method is provided wherein

the pressure of the heated gas is increased by the fan by at least 0.05 bar, preferably in the range of 0.1 up to including 2 bars;
the flow rate of the heated gas is taken to a value in the range of 0.3 m³/s up to and including 7 m³/s by the fan; and/or
the burner heats the heated gas such that near the outflow opening of the outlet channel it has a temperature in the range of 100° C. up to and including 300° C., for instance a temperature in the range of 150° C. up to and including 175° C., or preferably a temperature in the range of 125° C. up to and including 150° C.

Such a combination of pressure, flow rate and temperature ensures an optimal treatment with an optimal energy consumption and/or fuel consumption. Such a pressure increase also ensures an optimal flame-retarding action. In other words, the fan is configured to increase the pressure of the heated gas in order to achieve a flame-retarding action. It has turned out that in case of a sufficiently high flow rate of the heated gas, an efficient treatment is possible and that further increasing the temperature above the above-mentioned values contributes nothing or only very little to increasing the efficiency of the treatment. That way an efficient and fire-resistant treatment can be realized with optimal energy consumption as the temperature does not have to be needlessly increased in the burner and as the outflow of the gas heated by the burner can take place as optimally as possible because after the fan, hindering components such as for instance a burner, are not present in the flow path of the heated gas via the outlet channel, as a result of which the desired flow rate can also be efficiently realized.

According to another embodiment, a method is provided wherein during a treatment using the heated gas from the outflow opening of the outlet channel, the vegetation is exposed to the heated gas from the outflow opening for a time period of a maximum of 5 seconds, preferably a maximum of 1 second, preferably in the range of 0.5 s to 2 s. According to yet another embodiment, wherein the apparatus is attached to a vehicle, the treatment is preferably carried out at a driving speed of the vehicle of at least 3 km/h, preferably at least 6 km/h, for instance at least 10 km/h.

According to another embodiment, repeating the treatment of the vegetation using heated gas is provided, preferably the treatment of the vegetation is repeated twice or more often, at a frequency of twice a week or more often, for instance a repeated treatment in which within a period of one week the treatment is repeated three times. That way not only the parts of the vegetation above ground are damaged, but the repeated treatment also ensures that the photosynthesis is interrupted, resulting in the root dying off, as a consequence of which the treatment has a more permanent result.

According to another embodiment, a method is provided wherein:

the burner is selected from one of the following types:
a gas burner;
a burner for liquid fuel;
a burner for solid fuel;
the fan is selected from one of the following types:
a centrifugal fan;
an axial fan; and/or
the heated gas contains ambient air supplied through an inlet opening of the burner and heated by the burner.

That way the method can be realized in a robust manner using simple means.

According to a second aspect of the invention an apparatus is configured to control vegetation by means of a heated gas, comprising:

a burner configured to generate the heated gas; and
an outlet channel having an outflow opening configured to pass the heated gas to the vegetation to be controlled,

### CHARACTERIZED IN THAT

the apparatus further comprises:
a fan arranged between the burner and the outlet channel such that the fan is configured, while in operation, to suck in the heated gas from the burner and discharge it to the outlet channel and thereby to exhibit a flame-retarding action.

That way controlling vegetation can be realized in an efficient and fire-resistant manner. While in operation, the fan forms a mechanical barrier for the flames of the burner and furthermore the burner preferably is configured to increase the pressure of the heated gas in order for the fan to have an increased flame-retarding action.

According to an embodiment, an apparatus is provided wherein:

the burner comprises an outlet opening for the gas heated by the burner;
the fan comprises an inlet opening and an outlet opening; and
the outlet channel comprises an inlet opening and an outflow opening; and wherein:
the inlet opening of the outlet channel is connected to the outlet opening of the fan and the outlet channel forms a closed circuit for the heated gas from the inlet opening up to the outflow opening where the vegetation to be controlled is exposed to the heated gas; and
the outlet opening of the burner is connected to the inlet opening of the fan for sucking in the gas heated by the burner.

That way the heated gas is sucked in from the burner at the inlet of the fan and subsequently, at the outlet of the fan, is discharged via the outlet channel towards the vegetation to be treated, with a reduced risk of flames from the burner reaching the outlet opening due to the flame-retarding action of the fan which while in operation forms a mechanical obstruction for the flames.

According to another embodiment, an apparatus is provided, wherein the apparatus comprises no elements that are arranged in or after the outlet channel and that at least partially disrupt the flow of heated gas.

That way the desired flow rate of the heated gas is efficiently realized near the outflow opening of the outlet channel.

According to another embodiment, an apparatus is provided wherein the apparatus does not comprise a burner that is arranged in or downstream of the outlet channel; and/or the apparatus does not comprise a burner that is arranged downstream relative to the fan.

That way it is prevented that flames are able to reach the outflow opening of the outlet channel without the mechanical impediment of the fan as a result of which fire safety is increased.

According to another embodiment, an apparatus is provided wherein the apparatus comprises a pressure-increasing element that is arranged near the outlet opening of the fan.

The flame-retarding action of the fan is thus increased in a simple manner.

According to another embodiment, an apparatus is provided wherein:

the fan is configured to increasing the pressure of the heated gas by at least 0.05 bar, preferably in the range of 0.1 to 2 bars;
the fan is configured to take the flow rate of the heated gas to a value in the range of 0.3 m³/s up to and including 7 m³/s; and/or
the burner is configured to heat the heated gas such that near the outflow opening of the outlet channel it has a temperature in the range of 100° C. up to and including 300° C., preferably a temperature in the range of 125° C. up to and including 150° C., or a temperature in the range of 150° C. up to and including 175° C.

Such a selection of the pressure increase, flow rate and/or temperature ensures a fire-resistant treatment with an optimal efficiency as a result of which the treatment time can be reduced and/or the energy consumption and/or fuel consumption can be optimized.

According to another embodiment, an apparatus is provided wherein:

the burner is selected from one of the following types:
a gas burner;
a burner for liquid fuel;
a burner for solid fuel;
the fan is selected from one of the following types:
a centrifugal fan;
an axial fan; and/or
the burner comprises an inlet opening for ambient air, and the heated gas contains ambient air supplied through an inlet opening of the burner and heated by the burner.

That way the apparatus can be realized in a simple manner.

According to a third aspect of the invention, a method is provided for manufacturing an apparatus according to the first aspect of the invention, comprising the following steps:

providing the burner for generating the heated gas;
providing a blower unit comprising the fan and the outlet channel coupled downstream to the fan; coupling the blower unit to the burner, in such a way that the fan of the blower unit is configured to, while in operation, suck in the heated gas from the burner and discharge it to the outlet channel.

That way the apparatus according to the invention can be manufactured in a simple manner by making use of an existing blower unit by means of coupling an outflow opening for heated gas from a burner to the inlet opening of a blower of such a blower unit.

### FIGURES

By way of example some embodiments will be described on the basis of the related Figures, in which:

FIG. 1 schematically shows an embodiment of the method and the apparatus for controlling vegetation by means of a heated gas;

FIGS. 2A-C schematically show a front view, side view and top view, respectively, of another embodiment of such an apparatus in more detail; and

FIG. 3 schematically shows an embodiment of a method for manufacturing such an apparatus;

FIG. 4 schematically shows a further embodiment of an apparatus similar as shown in FIGS. 1-3; and

FIGS. 5A-B schematically shows a further embodiment of an apparatus similar as shown in FIGS. 1-4.

### DETAILED DESCRIPTION

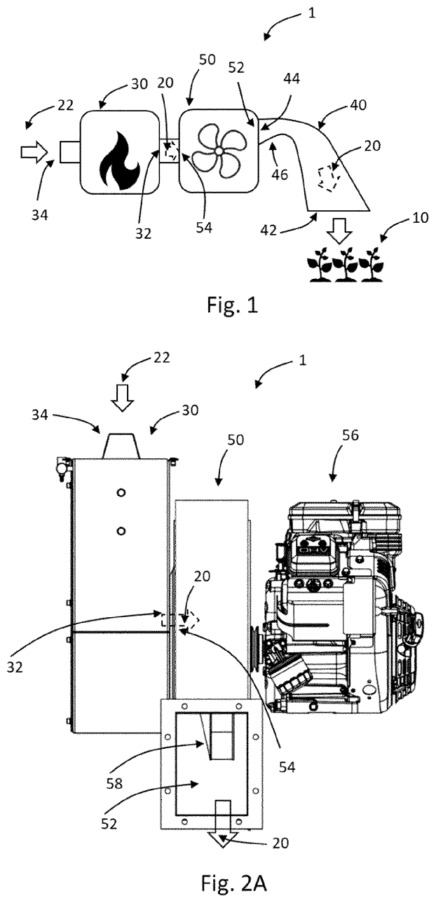

FIG. 1 schematically shows an embodiment of the method and an apparatus 1 for controlling vegetation 10 by means of a heated gas 20. Such vegetation may for instance comprise weed or other unwanted vegetation or plant material one wishes to destroy by exposure to the heat of the heated gas 20. The apparatus 1 comprises a burner 30, for instance a gas burner or any other suitable burner combusting a suitable fuel, to generate heat. According to the embodiment shown, the burner 30 therefore is configured to generate a heated gas 20. For that purpose, for instance ambient air 22 is supplied via an inlet opening 34 of the burner 30, wherein the burner 30 heats said ambient air via a suitable combustion element such as for instance a gas combustion element where supplied gas is combusted. Subsequently the gas 20 heated by the burner 30 is discharged via the outlet opening 32. It is clear that according to such an embodiment the heated gas 20 therefore contains the ambient air heated by the burner 30. Furthermore, it is clear that the heated gas 20 may optionally also contain other components such as for instance flue gases generated by the burner or other suitable additives for controlling vegetation.

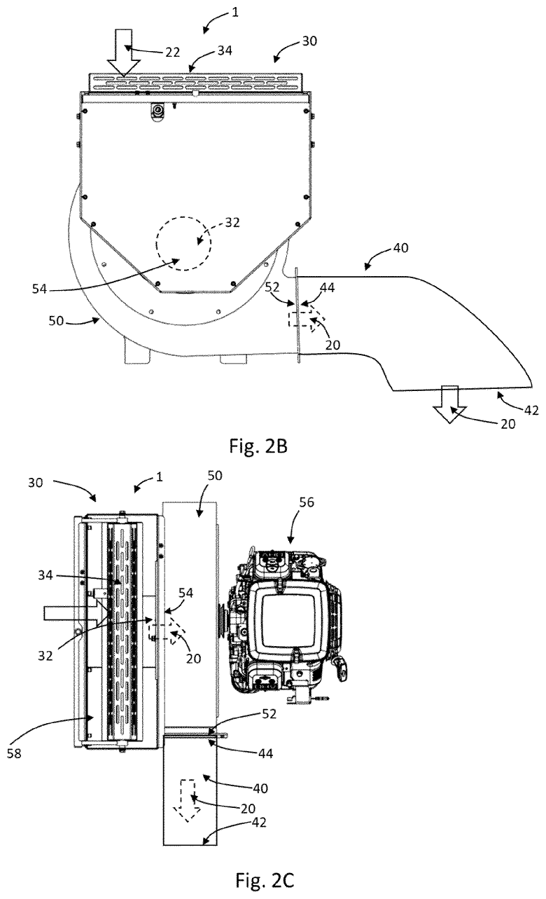

As can be seen in FIG. 1, the apparatus 1 further comprises a fan 50. Such a fan 50 or blower, as known to the skilled person, is configured to cause a flow in a gas. As can be seen, the fan 50 comprises an inlet opening 54 and an outlet opening 52. The outlet opening 32 of the burner 30 is connected to the inlet opening 54 of the fan 50 for sucking in the gas 20 heated by the burner 30. In operation, that means when driven by a suitable drive 56, as shown in more detail in FIGS. 2A-C, the fan 50 causes a flow in the gas 20 heated by the burner, according to a downstream direction from the inlet opening 54 towards the outlet opening 52 of the fan 50. It is clear that said flow of the heated gas 20 from the burner 30 via the outlet opening of the burner 30 also effects sucking in new ambient air via the inlet opening 34 of the burner 30.

According to the embodiment of FIG. 1, the apparatus furthermore also comprises an outlet channel 40. As can be seen, the outlet channel 40 comprises an inlet opening 44 and an outflow opening 42. In addition, the inlet opening 44 of the outlet channel 40 is connected to the outlet opening 52 of the fan 50. The outlet channel 40 for instance is configured like a tubular structure, a gas conduit, or another suitable embodiment of a closed circuit for the heated gas 20 from the inlet opening 44 up to the outflow opening 42. Near the outflow opening 42 the gas flows out of the outlet channel to the outside where the vegetation 10 to be controlled is exposed to the heated gas 20. Although the outlet channel 40 of the embodiment shown has a simple structure having a single inlet opening 44 and a single outflow opening 42 or outlet opening, it is clear that alternative embodiments are possible, wherein the outlet channel 40 can form a closed circuit wherein heated air is guided from one or more inlet openings to one or more outflow openings 42 for treating vegetation 10. Generally, the outlet channel 40 therefore comprises at least one outlet opening 42 configured to pass the heated gas 20 to the vegetation 10 to be controlled.

Therefore, it is clear that according to the flow path of the heated gas 20, the burner 30 is situated upstream of the fan 50 and that the outlet channel 40 is situated downstream of the fan. In other words, the fan 50 is arranged between the burner 30 and the outlet channel 40. While in operation, that means when the fan 50 is driven by a suitable drive 56, the fan will suck in heated gas 20 from the burner 30 and discharge it towards the outlet channel 40. In addition, the fan 50 exhibits a flame-retarding action. That means that the fan 50 forms a mechanical impediment for the flames created in the burner as a result of the combustion process of the fuel, such as for instance gas, for heating the heated gas up to a suitable temperature. That way it is prevented that the flames can reach the outlet channel 40 and in particular the outflow opening 42 of the outlet channel 40 and the vegetation to be treated, so that in this way increased fire safety of the apparatus 1 is effected.

It is also clear that according to the embodiment shown, the apparatus 1 preferably does not comprise elements that are arranged in or after the outlet channel 40 and that at least partially disrupt the flow of heated gas 20. According to the embodiment shown, in particular an apparatus 1 is realized, wherein no burner is present in the outlet channel 40 or is arranged downstream of the outlet channel 40. Furthermore, it is also clear that according to this embodiment, the apparatus 1 comprises no burner 30 that is arranged downstream relative to the fan 50. All this makes it possible to acquire the desired flow rate of the heated gas 20 near the outflow opening 42 of the outlet channel 40 in an efficient manner. Furthermore, it is thus also prevented that flames of the combustion process in the burner 30 are able to reach the outflow opening 42 of the outlet channel 40. The mechanical impediment of the fan 50 causes a flame-retarding action which thus increases the fire safety.

As indicated in FIG. 1, the apparatus furthermore also comprises a conical reduction 46 near the outlet opening 52 of the fan 50. According to this embodiment, said conical reduction 46 is formed as a reduction of the cross-section of the outlet channel 40 near the outlet opening 52, wherein for instance the cross-section is reduced by 50%. However, it is clear that alternative embodiments are possible wherein a reduction of the cross-section of the outlet channel 40 or the flow channel of the fan 50 near the outlet opening 52 show a suitable narrowing, for instance in the range of 5% up to and including 75%. Such a conical reduction 46 causes a specific pressure increase in the heated gas 20 near the outlet opening 52 of the fan 50 when the fan 50 is in operation. As stated above, the fire-retarding action of the fan 50 is increased that way in a preferred manner. It is clear that quite a few alternative embodiments are possible, as long as preferably the apparatus 1 comprises a pressure-increasing element 46 that is arranged near the outlet opening 52 of the fan 50.

FIGS. 2A-C schematically show a front view, side view and top view, respectively, of a further embodiment similar to the embodiment described above, in more detail. Similar elements are referred to with similar references and show a similar structure and operation as described above in relation to FIG. 1. The embodiment shown of the apparatus 1 of FIGS. 2A-C comprises a gas burner 30, a centrifugal fan 50 coupled downstream thereto and subsequently an outlet channel 40 coupled downstream thereto which is only shown in FIGS. 2B and 2C and for the sake of clarity has been left out in FIG. 2A. As can be seen, the fan sucks in heated gas 20 from the burner via a central inlet opening 54 and a blade element 58 driven by a combustion engine 56, while in operation, ensures the generation of a suitable flow in the heated gas 20 towards the outlet opening 52 of the fan 50 where it is passed further downstream via the outlet channel 40 towards the vegetation to be treated. As already stated above, such an apparatus 1 can be configured like a portable apparatus 1 or an apparatus 1 that is attached to a vehicle such as for instance tractor in order to move the outflow opening 42 along the vegetation 10 to be treated.

It is clear that alternative embodiments are possible, for instance instead of a centrifugal fan use can be made of another suitable type of fan, such as an axial fan for instance, etc. According to further alternative embodiments for instance instead of a gas burner use can be made of other types of burners that make use of a suitable liquid or solid fuel. The drive 56 shown of the fan 50 for instance comprises a suitable combustion engine. Particularly advantageous, for instance, is a combustion engine that makes use of the same fuel as the burner, such as for instance a combustion engine that makes use of gas in combination with a gas burner as in that case the same source of fuel can be made use of. However, it is clear that alternative embodiments are possible, wherein the fan 50 is provided with any other kind of suitable drive, such as for instance an electric motor, etc.

Preferably the fan 50 increases the pressure of the heated gas 20 by 0.1 to 1.5 bars. However, it is clear that alternative embodiments are possible, wherein preferably the pressure is increased by at least 0.05 bar, preferably in the range from 0.1 to 2 bars. That way an optimal flame-retarding action of the fan is achieved, and an efficient energy consumption of the fan is also realized. To reduce the treatment time of the vegetation in an efficient manner, the fan 50 preferably is configured to cause a flow rate of the heated gas 20 of at least at 5 m³/s. It is clear that alternative embodiments are possible, wherein an efficient treatment for instance is already possible at a flow rate in the range of 0.3 m³/s up to and including 7 m³/s, for instance at least 3 m³/s. Although a higher temperature of the heated gas 20 results in a more efficient treatment, it has turned out that a temperature in the range of 150° C. to 175° C. leads to optimal results and that a higher temperature leads to a limited increase only of the treatment time that insufficiently counterbalances the higher risk in terms of fire safety as well as the higher fuel consumption of the burner 30. Moreover, such a temperature is particularly suitable to allow for the heated gas to flow through the fan 50 without a risk of unacceptable temperatures for certain elements, such as for instance the bearings of the fan 50. It is clear that alternative embodiments are possible, wherein an efficient treatment of the vegetation 10 remains possible when the burner 30 is configured so as to heat the gas 20 such that near the outflow opening 42 of the outlet channel 40 it has a temperature of at least 50° C. Typically, a temperature of at least 80° C. is preferred, and in addition a good trade-off between the treatment time of the vegetation and the energy efficiency of the apparatus continues to exist at a temperature in the range of 100° C. up to and including 300° C. It is clear therefore that it is particularly advantageous to make use of a combination of the above-mentioned pressure increase, flow rate and/or temperature for a fire-resistant treatment with an optimal efficiency, as a result of which the treatment time can be reduced and/or the energy consumption and/or fuel consumption can be optimized.

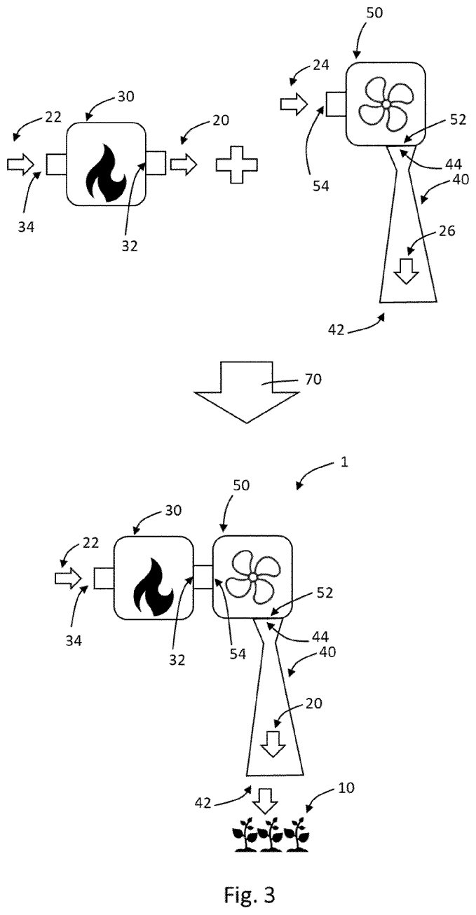

Next, a particularly advantageous embodiment for manufacturing an apparatus 1 is shown in FIG. 3, which embodiment is similar to the one described above in relation to FIGS. 1 and 2A-C. Similar elements are referred to by similar references and comprise a similar structure and function as described above. As can be seen, according to this method a burner 30 is provided for generating the heated gas 20, for instance a gas burner for heating ambient air 22 by means of a gas combustion element. In addition, a blower unit 60 is provided which comprises the fan 50 and the outlet channel 40 coupled downstream to the fan 50. According to an embodiment, such a burner 30 and such a blower unit 60 can be formed by apparatuses that are already known and available to the skilled person, such as for instance a known gas burner 30 and a leaf blower 60 or another suitable blower unit 60 that already comprises a blower 50 and an outlet channel 40 for sucking in ambient air 24 and blowing said ambient air 26 back out again. As can be seen, in step 70 of the embodiment of the method for manufacturing the apparatus 1 shown in FIG. 3, the blower unit 60 is coupled to the burner 30. As can be seen, the blower unit 60 is coupled to the burner 30, in such a way that the fan 50 of the blower unit 60 is configured to, while in operation, suck in the heated gas 20 from the burner 30 and discharge it to the outlet channel 40. In other words, the outlet opening 32 of the burner 30 is coupled to the inlet opening 54 of the fan 50 of the blower unit 60. That way, by means of simply coupling a burner 30 and a blower unit 60, the apparatus 1 can easily be manufactured by making a simple modification to such an existing blower unit 60.

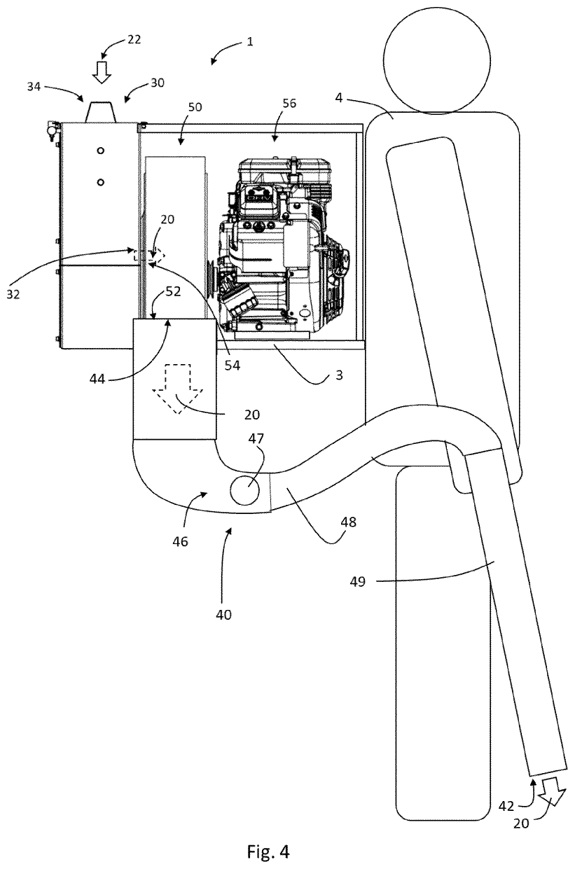

FIG. 4 shows another alternative embodiment of an apparatus 1 similar to the one described above in relation to FIG. 1, 2A-C or 3, suitable for carrying out the method of controlling vegetation 10 by means of a heated gas 20. Similar elements are referred to by similar references and comprise a similar structure and function as described above. As schematically shown, this embodiment comprises a few elements that have been modified to make portable use of the apparatus 1 possible. For instance, as can be seen, the burner 30 and the fan 50 were arranged on a suitable frame 3, which for instance is portable on the back of an operator 4 during carrying out the method described above by using the apparatus 1. As can be seen, according to this embodiment, the drive 56 of the fan 50 was also arranged on the frame 3. However, it is clear that alternative embodiments are possible, wherein one or more of the elements described above are arranged on the frame 3 by attaching them to another element, instead of attaching them directly to the frame 3. As can furthermore be seen, similar to what has been described above, the outlet channel 40 comprises a pressure-increasing element 46 arranged near the outlet opening 52 of the fan 50. Although the pressure-increasing element 46 is schematically shown as an element that reduces the flow-through opening of the outlet channel 40 at or near the outflow opening 52 of the fan 50, it is clear that alternative embodiments are possible, as has already been stated above. According to the embodiment shown, the pressure-increasing element 46 for instance comprises an adjustable pressure-increasing element 47, such as for instance an adjustable valve 47 capable of influencing the flow-through of the heated ambient air 20, for instance by varying the flow-through opening of the outlet channel 40 near the pressure-increasing element 46 by means of an adjustable valve element, so that a desired value for the pressure increase as well the flow rate of the heated air can be fine-tuned by the operator 4, for instance depending on the vegetation to be controlled or ambient parameters such as the temperature or the humidity. In addition, it is clear that the pressure-increasing element 46, optionally comprising an adjustable pressure-increasing element 47, similar to the one described above, will always realize a sufficient pressure increase to effect the flame-retarding action of the fan 50. As can furthermore be seen, the embodiment shown in FIG. 4 comprises an outlet channel 40, for instance a flexible part 48, for instance a flexible tube or hose, which enables the operator 4 to aim the outflow opening 42 at the vegetation to be treated. As can be seen, preferably downstream of said flexible part 48, this embodiment furthermore comprises a rigid elongated part 49, such as for instance a tube or conduit, which preferably is sufficiently long for, when as shown, the operator 4 manipulates its upstream end, the downstream end, which also forms the outflow end 42, to be situated near the ground for treating the vegetation. However, it is clear that quite a few varieties of embodiments are possible, wherein such an ergonomic configuration for a portable apparatus 1 for performing the method described above is realized. As can be seen, in case of a portable apparatus 1, preferably the burner 30 and/or fan 50 are arranged on the frame 3 as far away from the operator 4 as possible, so as to reduce the risk of contacting these hot elements. According to a further alternative embodiment, it is also possible to provide the frame 3 with wheels and configure it for instance like a cart that the operator 4 can move along with them. According to a further alternative embodiment, the operator 4 can move such a cart onward by means of the outlet channel 40, as a result of which such cart is configured so as to drag behind the outlet channel 40 manipulated by the operator 4.

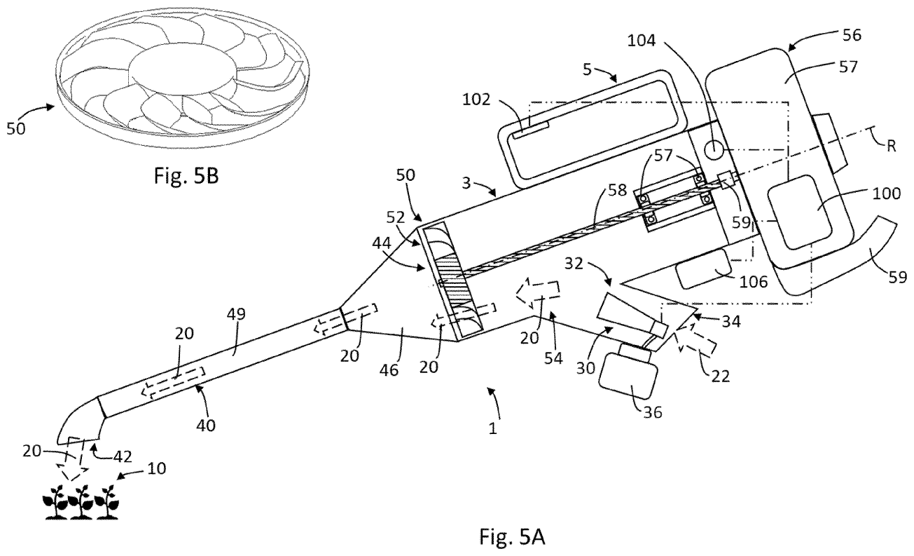

FIGS. 5A and 5B show still a further alternative embodiment of an apparatus 1 similar to the one described above in relation to FIG. 4, suitable for carrying out the method of controlling vegetation 10 by means of a heated gas 20. Similar elements are referred to by similar references and comprise a similar structure and function as described above. FIG. 5A schematically shows a partial section of the embodiment of the apparatus 1 along a central rotary axis R of the fan 50. FIG. 5B, shows a perspective view on the specific embodiment of the fan 50 in more detail.

As schematically shown, also this embodiment comprises a few elements that have been provided to make portable use of the apparatus 1 possible. For instance, as can be seen, the burner 30 and the fan 50 were arranged in or on a suitable housing or frame 3, which for instance is portable by an operator 4 during carrying out the method described above by using the apparatus 1. As shown, according to this embodiment, there is arranged in or on the housing 3 a handle 5 configured to allow the apparatus to be carried by hand by an operator.

As further shown in FIG. 5A, according to this embodiment, the drive 56 of the fan 50 was also arranged on the housing 3 of the apparatus. However, it is clear that alternative embodiments are possible, wherein one or more of the elements described above are arranged in and/or on the housing 3 by arranging them in and/or on another element, instead of attaching them directly to the housing or frame 3. As shown in more detail in FIG. 5B, according to this embodiment the fan 50 is embodied as a suitable axial fan. This axial fan 50 causes gas to flow through it in an axial direction, parallel to the central rotation axis R of the drive shaft 58 about which the blades of the fan 50 rotate by means of the drive 56. It is clear that alternative embodiments than the fan 50 shown in FIG. 5B are possible, in which for example another type and/or number of blades ore used. According to a particular embodiment drive 56 could be embodied as any suitable rotary drive coupled to the drive shaft 58, such as for example an internal combustion engine 57 provided with a suitable fuel tank 59 for providing fuel for its operation. A suitable drive 56 could be a suitable internal combustion engine, with a sufficiently low weight to allow for an apparatus which is sufficiently light weight, such as for example similar as motor manufactured by Honda, known as model Gx35 or Gx50, or any other suitable internal combustion engine, such as a two-stroke or four-stroke type of engine with a suitable power level, such as for example associated with a cylinder volume of for example 25 cc, 35 cc or 50 cc, or any other suitable range. However, it is clear that alternative examples are possible, such as for example any other suitable drive, such as an electric motor, a gas drive motor, etc. As shown in FIG. 5A, the drive shaft 58 could be rotatably arranged in the housing 3 by means of suitable bearings 57 and be coupled to the drive 56 by means of a suitable coupling 59. According to the embodiment shown, the fan 50 is rotated in a substantial cylindrical part of the housing 30 comprising a central axis coaxial to the rotational axis R. According to a further alternative embodiment, instead of a single axial fan 50, there could be arranged a cascade of two, three or more of such axial fans 50 along the central rotation axis R, in order to obtain the desired level of flow of the heated gas 20.

According to the embodiment shown, the burner 30, is for example embodied similar as described above as a gas burner 30 or any other suitable burner combusting a suitable fuel, to generate heat. According to the embodiment shown, the burner 30 therefore is configured to generate a heated gas 20. According to a particular embodiment the burner 30 could for example be embodied as a gas burner similar as the one known from WO2018027285, which is suitable to operate at the desired level of flow of the heated gas 20 as generated by the fan 50. Preferably the burner 30 comprises a flame detection safety system, which prevents that unsafe amounts of gas are released if during a predetermined period no suitable flame is detected, such as for example by means of a suitable ionization detector, or any other suitable flame detector.

As can furthermore be seen, similar to what has been described above, the outlet channel 40 comprises a pressure-increasing element 46 arranged near the outlet opening 52 of the fan 50. Although the pressure-increasing element 46 is schematically shown as a conical element that reduces the flow-through opening of the outlet channel 40 at or near the outflow opening 52 of the fan 50, it is clear that alternative embodiments are possible, as has already been stated above. It is clear that such a pressure-increasing element 46 is configured to realize a sufficient pressure increase to effect an improved flame-retarding action of the fan 50 as already mentioned above.

As can furthermore be seen, the embodiment shown in FIG. 5A comprises an outlet channel 40 which enables the operator 4 to aim the outflow opening 42 at the vegetation to be treated. As shown, according to this embodiment the outlet channel 40 comprises for example a rigid elongated part 49 downstream of the pressure-increasing element 46, such as for instance a tube or conduit. Preferably, the outlet channel 40 is sufficiently long such that, when the operator 4 holds the apparatus 1 at the handle 5, the downstream end, which also forms the outflow end 42, will be situated near the ground for treating the vegetation 10. However, it is clear that alternative embodiments are possible. As shown, similar as described above, also according to this embodiment of a portable apparatus 1, preferably the burner 30 and/or fan 50 are arranged in or on the housing or frame 3 as at a side facing away from the handle 5 for holding the apparatus 1 by the operator, so as to reduce the risk of contacting these hot elements.

As further shown, according to this embodiment, there is arranged a gas reservoir 36, such as for example a suitable gas cylinder, gas tank, gas cartridge, etc. with a suitable volume of pressurized gas, such as for example 750 ml, 2, 3, 4, or 5 kg or any other suitable amount of gas to supply to the burner 30. According to the embodiment shown, the gas reservoir 36 is arranged on the housing or frame 36, which limits the amount of such a reservoir 36 to an amount which corresponds to a weight that is still sufficiently light to be carried around by an operator. However, according to a further alternative embodiment, it is also possible to provide for instance a cart that the operator can move along with him, on which a heavier gas supply can be arranged, which is suitable coupled to the burner 30 of the apparatus for supplying the gas, for example by means of a suitable flexible hose, tube or conduit between the gas reservoir 36 and the burner 30.

As further shown in FIG. 5A, the apparatus 1 could for example be controlled by means of a suitable controller 100, which controls the operation of different elements of the apparatus in function of suitable inputs, such as for example input means for the operator, sensors, etc. suitably coupled to this controller 100, which comprises a suitable processor and memory means, programmed with a suitable computer readable instructions, which when executed by the processor are able to output suitable control signals which control the operation of elements such as the drive 56, the burner 30, etc. in order to accomplish the desired method of operation of the apparatus 1 as for example described in more detail below. It is clear that a similar mode of operation, by means of such a controller could also be provided for other embodiments of the apparatus as described above. According to a particular advantageous method for controlling the apparatus, as for example shown in FIG. 5A, there is coupled an activation switch, throttle or any other suitable input element 102 for the operator to the controller 100. As shown, preferably this input element 102 is preferably arranged in the handle 5 of the apparatus, for easy manipulation by the operator. Upon activation/deactivation or manipulation of this input element 102, the controller 100 will activate/deactivate and/or control the drive 56 to a desired rotational speed. According to a particular embodiment, the rotational speed upon activation could be set to one or more fixed values, however, according to alternative embodiments, there could be provided a throttle 102, which allows to vary the rotational speed in a particular range, thereby allowing a corresponding variation of a suitable flow rate to be generated by the fan 50. As shown according to this embodiment the apparatus also comprises a speed sensor 104 coupled to the controller 100 in such a way that the controller is able to monitor the rotational speed of the drive 56 and/or the fan 50 coupled thereto. According to the embodiment of the controller 100 shown, the controller 100 could be configured, for example to automatically activate or deactivate the burner 30 in function of the rotational speed of the fan 50 and/or the drive 56. According to a particular simple and reliable embodiment the burner 30 could be activated when the rotational speed exceeds a predetermined threshold value and deactivated when the rotational speed does not exceed this predetermined threshold value. According to the embodiment shown, the threshold value could for example be 5000 rotations per minute, or any other suitable threshold value, which corresponds to the fan 50 causing a desired flow rate, or exceeding a desired minimal flow rate, to allow for a safe operation of the burner 30, without the risk of overheating the apparatus 1. As shown, according to the embodiment of FIG. 5, the heater 30 could be suitable coupled to the controller to control its operation, for example by means of a suitable electronic valve which controls the supply of gas to the burner, a control system for initiating ignition of the gas in the burner, a sensor for monitoring the presence of a flame, a sensor for monitoring the temperature, etc. It is clear that still further alternative embodiments are possible, for example in which the operation of the burner 30 is controlled by the controller 100 in function of a temperature sensor which measures the temperature of the heated gas 20, such that the desired temperature for the heated gas 20 is reached during activation of the apparatus 1. Further, according to the embodiment shown, there is coupled a suitable power source, such as for example a battery 106 to the controller 100 for supplying the necessary power for the operation of the controller and/or any of the input and/or output elements coupled thereto.

Furthermore, it is clear that the use of an apparatus 1 as described above for controlling vegetation by means of heated gas 20 in a suitable manner, blows out the heated gas downwards onto the vegetation to be controlled. That means that the apparatus 1 discharges the heated air 20 out of the outflow opening 42 of the outlet channel 40 according to a downward direction, directed at the ground surface. That means at a suitable angle to the ground surface, which angle is in the range of 30° up to and including 150°, preferably 60° up to and including 120°, for instance 75° up to and including 105°, for instance 90°+/−5° to the ground surface.

It is clear that in addition to the embodiments described above, quite a few varieties of embodiments and further combinations are possible without departing from the scope of protection as defined by the claims.

1.-15. (canceled)

16. A method for a control of vegetation by means of a heated gas that is generated in a burner and which via an outflow opening of an outlet channel is passed to the vegetation to be controlled;
wherein between the burner and the outlet channel a fan is arranged such that the fan, while in operation, sucks in the heated gas from the burner and discharges it to the outlet channel and thereby exhibits a flame-retarding action.

17. The method according to claim 16, wherein:
an inlet opening of the outlet channel is connected to an outlet opening of the fan and the outlet channel forms a closed circuit for the heated gas from the inlet opening up to the outflow opening where the vegetation to be controlled is exposed to the heated gas; and
an outlet opening of the burner is connected to an inlet opening of the fan for sucking in the gas heated by the burner.

18. The method according to claim 16, wherein no elements that at least partially disrupt a flow of heated gas are arranged in or after the outlet channel.

19. The method according to claim 16, wherein no burner is arranged in or downstream of the outlet channel; and/or no burner is arranged downstream relative to the fan.

20. The method according to claim 16, wherein a pressure-increasing element is arranged near the outlet opening of the fan.

21. The method according to claim 16, wherein:
a pressure of the heated gas is increased by the fan by at least 0.05 bar;
the flow rate of the heated gas is taken to a value in the range of 0.3 m³/s up to and including 7 m³/s by the fan; and/or
the burner heats the heated gas such that near the outflow opening of the outlet channel it has a temperature of at least 50° C.

22. The method according to claim 16, wherein:
the burner is selected from one of the following types:
a gas burner;
a burner for liquid fuel;
a burner for solid fuel;
the fan is selected from one of the following types:
a centrifugal fan;
an axial fan; and/or
the heated gas contains ambient air supplied through an inlet opening of the burner and heated by the burner.

23. An apparatus configured to control vegetation by means of a heated gas, comprising:
a burner configured to generate the heated gas; and
an outlet channel having an outflow opening configured to pass the heated gas to the vegetation to be controlled,
wherein the apparatus further comprises:
a fan arranged between the burner and the outlet channel such that the fan is configured, while in operation, to suck in the heated gas from the burner and discharge it to the outlet channel and thereby to exhibit a concurrent flame-retarding action.

24. The apparatus according to claim 23, wherein:
the burner comprises an outlet opening for the gas heated by the burner;
the fan comprises an inlet opening and an outlet opening; and
the outlet channel comprises an inlet opening and an outflow opening; and
wherein:
the inlet opening of the outlet channel is connected to the outlet opening of the fan and the outlet channel forms a closed circuit for the heated gas from the inlet opening up to the outflow opening where the vegetation to be controlled is exposed to the heated gas; and
the outlet opening of the burner is connected to the inlet opening of the fan for sucking in the gas heated by the burner.

25. The apparatus according to claim 23, wherein the apparatus comprises no elements that have been arranged in or after the outlet channel and that at least partially disrupt the flow of heated gas.

26. The apparatus according to claim 23, wherein the apparatus does not comprise a burner that is arranged in or downstream of the outlet channel; and/or
the apparatus does not comprise a burner that is arranged downstream relative to the fan.

27. The apparatus according to claim 23, wherein the apparatus comprises a pressure increasing element arranged near the outlet opening of the fan.

28. The apparatus according to claim 23, wherein:
the fan is configured to increase the pressure of the heated gas by at least 0.05 bar, preferably in the range of 0.1 to 2 bars;
the fan is configured to take the flow rate of the heated gas to a value in the range of 0.3 m³/s up to and including 7 m³/s; and/or
the burner is configured to heat the heated gas such that near the outflow opening of the outlet channel it has a temperature of at least 50° C.

29. The apparatus according to claim 23, wherein:
the burner is selected from one of the following types:
a gas burner;
a burner for liquid fuel;
a burner for solid fuel;
the fan is selected from one of the following types:
a centrifugal fan;
an axial fan; and/or
the burner contains an inlet opening for ambient air, and the heated gas contains ambient air supplied through an inlet opening of the burner and heated by the burner.

30. A method for manufacturing an apparatus according to claim 23, comprising the following steps:
providing the burner for generating the heated gas;
providing a blower unit comprising the fan and the outlet channel coupled downstream to the fan;
coupling the blower unit to the burner, in order for the fan of the blower unit, while in operation, to suck in the heated gas from the burner and discharge it to the outlet channel.
